(19) United States
(12) Patent Application Publication
(10) Pub. No.: US 2024/0410298 A1
(43) Pub. Date: Dec. 12, 2024

(54) STEAM TURBINE

(71) Applicant: MITSUBISHI HEAVY INDUSTRIES COMPRESSOR CORPORATION, Tokyo (JP)

(72) Inventors: Takuro Koda, Hiroshima-shi (JP); Katsumi Terada, Hiroshima-shi (JP); Tomotaka Ouchi, Hiroshima-shi (JP)

(73) Assignee: MITSUBISHI HEAVY INDUSTRIES COMPRESSOR CORPORATION, Tokyo (JP)

(21) Appl. No.: 18/735,310

(22) Filed: Jun. 6, 2024

(30) Foreign Application Priority Data
Jun. 8, 2023 (JP) 2023-094964

(51) Int. Cl. F01D 25/32; F01D 1/06

(52) U.S. Cl. CPC F01D 25/32; F01D 1/06; F05D 2260/602; F05D 2300/51

(57) ABSTRACT

A steam turbine has a plurality of stages constituted of pairs of a rotor blade and a stator vane arranged in an axial direction. A casing has a casing opening portion which allows water droplets circulating in a main flow channel to flow in therethrough. The rotor blade has a plurality of rotor blade hydrophilic portion which guide the water droplets that have adhered to a rotor blade surface toward the casing opening portion. The stator vane has a drain suction port which opens on a stator vane surface extending in a radial direction and allows the water droplets that have adhered to the stator vane surface to flow in therethrough, and a plurality of stator vane hydrophilic portions which are formed with a gap therebetween in the radial direction with respect to the stator vane surface and guide the water droplets that have adhered to the stator vane surface toward the drain suction port.

### BACKGROUND OF THE INVENTION

### Field of the Invention

The present disclosure relates to a steam turbine.

Priority is claimed on Japanese Patent Application No. 2023-094964, filed Jun. 8, 2023, the content of which is incorporated herein by reference.

### Description of Related Art

A steam turbine includes a rotor (turbine rotor) which is disposed inside a casing, rotor blade rows which are provided on an outward side of the rotor in a radial direction, and stator vane rows which are provided on an inward side of the casing in the radial direction.

In the steam turbine, the pressure becomes extremely low when being close to the last stage. For this reason, circulating steam eventually reaches a saturated steam pressure and is in a wet steam state containing liquefied fine water droplets (water droplet nuclei). Most of these fine water droplets (drain) pass through between rotor blades and the stator vanes together with the steam, but some of them adhere to rotor blade surfaces due to inertia. Water droplets that have adhered to the rotor blade surfaces form liquid films on the rotor blade surfaces.

In this regard, for example, Patent Document 1 describes a steam turbine in which band-shaped hydrophobic area and band-shaped hydrophilic area are alternately disposed in at least parts on stator vane surfaces of stator vanes. In the stator vanes of the steam turbine in Patent Document 1, water on the stator vane surfaces is induced from an outward side toward an inward side in a radial direction, and a frequency of occurrence of erosion and a rate of progress of erosion in rotor blades disposed on a downstream side are curbed.

### PATENT DOCUMENT

[Patent Document 1] Japanese Unexamined Patent Application, First Publication No. 2017-20443

### SUMMARY OF THE INVENTION

Incidentally, in order to eliminate drain, such a steam turbine described above has a structure with an opening formed to discharge drain through a main flow channel through which steam circulates to rotor blades and a casing. In a steam turbine having such a structure, it is required to induce water droplets to the opening without depending on the flow of steam in the main flow channel.

The present disclosure provides a steam turbine capable of efficiently inducing water droplets to an opening without depending on the flow of steam in a main flow channel.

A steam turbine according to the present disclosure includes a rotor shaft which is capable of rotating about an axis, a plurality of rotor blades which are fixed to an outward side of the rotor shaft in a radial direction with respect to the axis, a casing which covers the rotor shaft and the plurality of rotor blades from the outward side in the radial direction and in which a main flow channel allowing steam to circulate therethrough is formed, and a plurality of stator vanes which are fixed to an inward side of the casing in the radial direction and disposed on a first side in an axial direction with respect to the plurality of rotor blades. The steam turbine comprises a plurality of stages which constituted of pairs of each of the plurality of rotor blades and each of the plurality of stator vanes arranged in the axial direction. The casing has a casing opening portion which opens on an inner circumferential surface facing tip of each of the plurality of rotor blades and allows water droplets circulating in the main flow channel to flow in therethrough on a second side in the axial direction with respect to each of the plurality of rotor blades in at least one of the plurality of stages. Each of the plurality of rotor blades, which disposed in at least one of the plurality of stages, has a plurality of rotor blade hydrophilic portions which are formed with a gap therebetween in the radial direction with respect to a rotor blade surface extending in the radial direction and guide the water droplets that have adhered to the rotor blade surface toward the casing opening portion. Each of the plurality of stator vanes, which disposed in at least one of the plurality of stages, has a drain suction port which opens on a stator vane surface extending in the radial direction and allows the water droplets that have adhered to the stator vane surface to flow in therethrough, and a plurality of stator vane hydrophilic portions which are formed with a gap therebetween in the radial direction with respect to the stator vane surface and guide the water droplets that have adhered to the stator vane surface toward the drain suction port.

According to the steam turbine of the present disclosure, it is possible to efficiently induce water droplets to an opening without depending on a flow of steam in a main flow channel.

### BRIEF DESCRIPTION OF THE DRAWINGS

FIG. 1 is a schematic view showing the overall constitution of a steam turbine according to the present embodiment.

FIG. 2 is a cross-sectional view showing rotor blade rows and stator vane rows of the steam turbine.

FIG. 3 is a cross-sectional view showing a stator vane having stator vane hydrophilic portions and a rotor blade having rotor blade hydrophilic portions of the steam turbine.

### DETAILED DESCRIPTION OF THE INVENTION

Hereinafter, with reference to the accompanying drawings, forms for performing a steam turbine according to the present disclosure will be described. However, the present disclosure is not limited to this embodiment only.

### (Constitution of Steam Turbine)

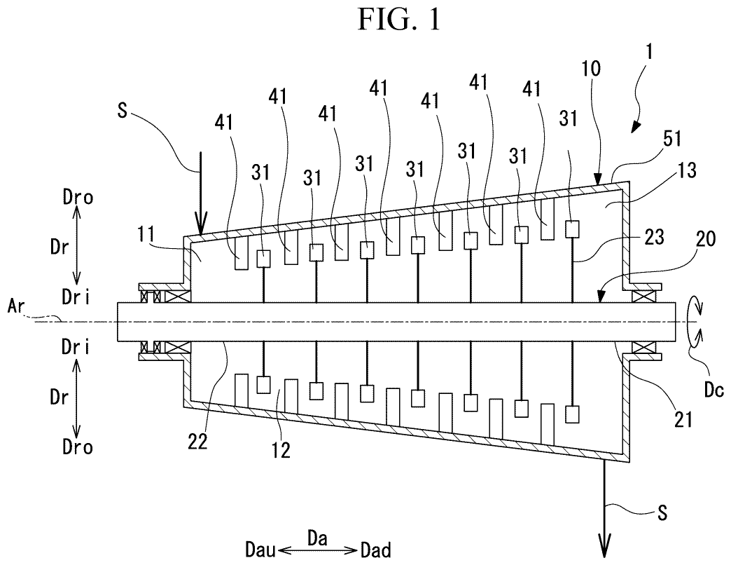

As shown in FIG. 1, a steam turbine 1 of the present embodiment has a rotor 20 rotating about an axis Ar, a casing 10 rotatably covering the rotor 20, and a plurality of stator vane rows 41.

For the sake of convenience of the description below, a direction in which the axis Ar extends will be referred to as an axial direction Da. A first side in the axial direction Da will be referred to as an upstream side (one side) Dau, and a second side in the axial direction Da will be referred to as a downstream side (the other side) Dad. In addition, a radial direction Dr in the rotor 20 with respect to the axis Ar will be simply referred to as the radial direction Dr. A side closer to the axis Ar in this radial direction Dr will be referred to as an inward side Dri in the radial direction Dr, and in this radial direction Dr, a side opposite to the inward side Dri in the radial direction Dr will be referred to as an outward side Dro in the radial direction Dr. In addition, a circumferential direction of the rotor 20 about the axis Ar will be simply referred to as a circumferential direction Dc.

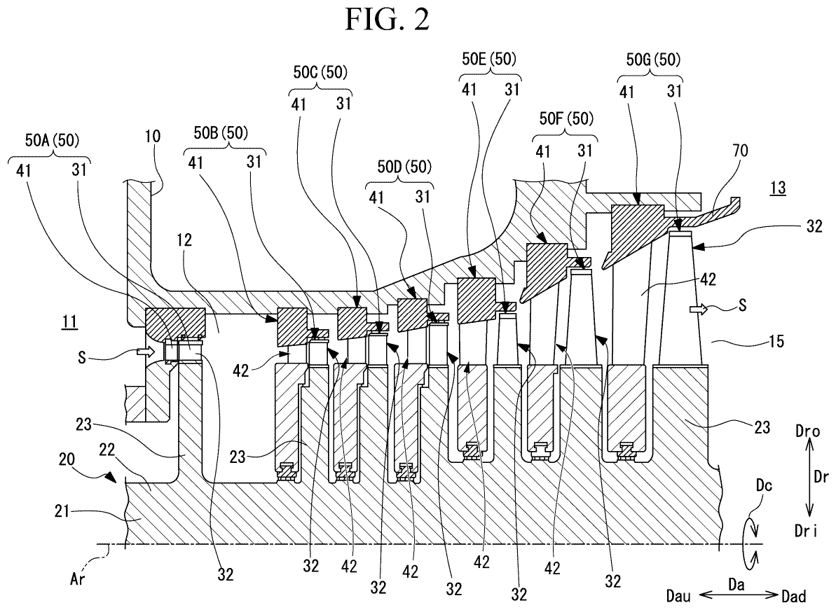

As shown in FIGS. 1 and 2, the rotor 20 has a rotor shaft 21 and a plurality of rotor blade rows 31.

The rotor shaft 21 can rotate about the axis Ar with respect to the casing 10. The rotor shaft 21 has a shaft core portion 22 and a plurality of disk portions 23. The shaft core portion 22 is formed to have a columnar shape about the axis Ar and extends in the axial direction Da. The disk portions 23 spread from the shaft core portion 22 to the outward side Dro in the radial direction Dr. The disk portions 23 are arranged with a gap therebetween in the axial direction Da. The disk portion 23 is disposed for each of the plurality of rotor blade rows 31.

The rotor blade rows 31 are fixed to the outward side Dro of the rotor shaft 21 in the radial direction Dr. Specifically, as shown in FIG. 2, the rotor blade rows 31 are fixed to the outward side Dro of the disk portions 23 that is an outer circumferential part of the rotor shaft 21 in the radial direction Dr. The plurality of rotor blade rows 31 are disposed with a gap therebetween in the axial direction Da of the rotor shaft 21. In the case of the present embodiment, for example, seven rotor blade rows 31 in total from the rotor blade row 31 positioned on the furthest upstream side Dau in the axial direction Da to the rotor blade row 31 positioned on the furthest downstream side Dad in the axial direction Da are disposed. Each of the rotor blade rows 31 has a plurality of rotor blades 32 arranged in the circumferential direction Dc. The plurality of rotor blades 32 are fixed to the outward side Dro of the rotor shaft 21 in the radial direction Dr. The plurality of rotor blades 32 are respectively attached to the disk portions 23. Each of the rotor blades 32 extends from the disk portion 23 to the outward side Dro in the radial direction Dr. Each of the rotor blades 32 is disposed inside a main flow channel 15 (which will be described below). Each of the rotor blades 32 has a rotor blade profile cross section when viewed from the outward side Dro in the radial direction Dr.

The casing 10 is formed to cover the rotor shaft 21 and the plurality of rotor blades 32 from the outward side Dro in the radial direction Dr. The main flow channel 15 allowing steam S to circulate therethrough is formed inside the casing 10. Specifically, in the casing 10, a nozzle chamber 11 into which the steam S flows from the outside, a flow channel chamber 12 through which the steam S from the nozzle chamber 11 flows, and an exhaust chamber 13 which discharges the steam S that has flowed from the flow channel chamber 12 are formed. The rotor blade row 31 and the stator vane row 41, of the plurality of rotor blade rows 31 and the plurality of stator vane rows 41, in a first stage 50A on the furthest upstream side Dau are disposed between the nozzle chamber 11 and the flow channel chamber 12. In other words, the inside of the casing 10 is partitioned into the nozzle chamber 11 and the flow channel chamber 12 by the rotor blade row 31 and the stator vane row 41 on this furthest upstream side Dau. The main flow channel 15 through which the high-pressure steam S circulates is constituted of the nozzle chamber 11, the flow channel chamber 12, and the exhaust chamber 13.

In addition, the casing 10 further includes an exhaust casing 51 and a diffuser 70.

The exhaust casing 51 is connected to the outside of the casing 10. The exhaust casing 51 discharges the steam S that has flowed through the main flow channel 15 to the outside of the casing 10. The exhaust casing 51 is disposed on the furthest downstream side Dad in the axial direction Da in the casing 10. The exhaust chamber 13 opening downward is formed in a lower portion of the exhaust casing 51. The exhaust casing 51 exhausts the steam S whose static pressure has been recovered by the diffuser 70 (which will be described below) to the outside.

The diffuser 70 guides the steam S that has flowed out from the rotor blade row 31 in a seventh stage 50G to the outside of the casing 10 via the exhaust chamber 13. The diffuser 70 is disposed between the rotor blade row 31 in the seventh stage 50G and the exhaust casing 51 forming the exhaust chamber 13 in the casing 10.

In the main flow channel 15, the high-pressure steam S flows from the upstream side Dau toward the downstream side Dad while the pressure gradually falls. The main flow channel 15 is formed to have a ring shape around the rotor shaft 21. The main flow channel 15 extends in the axial direction Da in a manner of straddling the plurality of rotor blade rows 31 and the plurality of stator vane rows 41. A part of the main flow channel 15 is formed by a ring-shaped space in which stator vanes 42 (which will be described below) are disposed.

The stator vane rows 41 include the plurality of stator vane rows 41 fixed to the inward side Dri of the casing 10 in the radial direction Dr. The plurality of stator vane rows 41 are disposed with a gap therebetween in the axial direction Da. For example, in the present embodiment, seven stator vane rows 41 in total from the stator vane row 41 positioned on the furthest upstream side Dau in the axial direction Da to the stator vane row 41 positioned on the furthest downstream side Dad in the axial direction Da are disposed. The stator vane rows 41 are disposed side by side on the upstream side Dau with respect to the respectively corresponding rotor blade rows 31.

Each of the stator vane rows 41 has a plurality of stator vanes 42 arranged in the circumferential direction Dc. The plurality of stator vanes 42 are disposed with a gap therebetween in the circumferential direction Dc. The stator vanes 42 are fixed to the inward side Dri of the casing 10 in the radial direction Dr. The stator vanes 42 are fixed to an inner circumferential surface of the casing 10. The inner circumferential surface of the casing 10 is a surface facing the main flow channel 15 toward the inward side Dri in the radial direction Dr in the casing 10. The inner circumferential surface of the casing 10 is a surface facing tips of the rotor blades 32 at a position shifted in the axial direction Da from the position where the stator vanes 42 are fixed.

One stage 50 is formed by each set of the rotor blade row 31 and one stator vane row 41 arranged on the upstream side Dau of this rotor blade row 31. Namely, one stage 50 is constituted of a pair of the rotor blade 32 and the stator vane 42 arranged in the axial direction Da. Therefore, with respect to the plurality of rotor blades 32 arranged in the circumferential direction Dc, the plurality of stator vanes 42 arranged in the circumferential direction Dc are disposed on the upstream side Dau in the axial direction Da. In the steam turbine 1 of the present embodiment, in FIG. 2, the stator vane rows 41 are disposed with respect to the seven rotor blade rows 31, respectively. For this reason, seven stages 50 are provided. Namely, the steam turbine 1 of the present embodiment includes, in order from the upstream side Dau to the downstream side Dad, the rotor blade rows 31 and the stator vane rows 41 in the first stage 50A, a second stage 50B, a third stage 50C, a fourth stage 50D, a fifth stage 50E, a sixth stage 50F, and the seventh stage 50G.

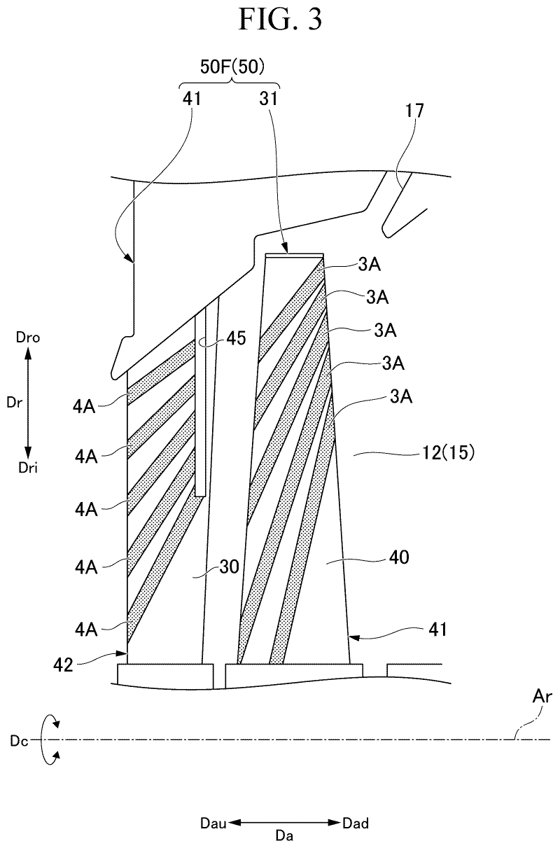

In addition, as shown in FIG. 3, in the steam turbine 1 of the present embodiment, the casing 10 has a casing opening portion 17 which allows water droplets circulating in the main flow channel 15 to flow in therethrough. The casing opening portion 17 is a drain catcher discharging water droplets that have moved to the outward side Dro in the radial direction Dr in the main flow channel 15 to the outside. The casing opening portion 17 opens on the inner circumferential surface of the casing 10 facing the tips of the rotor blades 32. The casing opening portion 17 opens on the downstream side Dad in the axial direction Da with respect to the rotor blade 32 in at least one stage 50 and on the upstream side Dau in the axial direction Da with respect to the stator vane 42 in the next stage 50 positioned on the further downstream side Dad. Therefore, the casing opening portion 17 is formed between adjacent stages 50 in the axial direction Da. In the present embodiment, the casing opening portion 17 is disposed on the downstream side Dad in the axial direction Da with respect to the rotor blades 32 in the fifth stage 50E and the sixth stage 50F. Namely, the casing opening portion 17 is disposed on the downstream side Dad in the axial direction Da with respect to the rotor blade 32 in the fifth stage 50E and on the upstream side Dau in the axial direction Da with respect to the stator vane 42 in the sixth stage 50F. In addition, the casing opening portion 17 is disposed on the downstream side Dad in the axial direction Da with respect to the rotor blade 32 in the sixth stage 50F and on the upstream side Dau in the axial direction Da with respect to the stator vane 42 in the seventh stage 50G. The casing opening portion 17 is disposed on the outward side Dro in the radial direction Dr with respect to the rotor blades 32. Accordingly, water droplets that are blown in a manner of scattering toward the outward side Dro in the radial direction Dr by the rotor blades 32 flow into the casing opening portion 17.

In addition, the rotor blade 32 disposed in at least one stage 50 of the present embodiment has a plurality of rotor blade hydrophilic portions 3A on a rotor blade surface 30 that is its own rotor blade surface. In the present embodiment, the rotor blades 32 in the fifth stage 50E and the sixth stage 50F each have the rotor blade hydrophilic portions 3A, and the sixth stage 50F will be described as an example.

Each of the rotor blade hydrophilic portions 3A guides water droplets that have adhered to the rotor blade surface 30 toward the casing opening portion 17. The rotor blade hydrophilic portions 3A are formed to have higher hydrophilicity than the rotor blade surface 30. Namely, water droplets are more likely to adhere to the rotor blade hydrophilic portions 3A than to the rotor blade surface 30. In order to enhance the hydrophilicity with respect to the rotor blade surface 30, the rotor blade hydrophilic portions 3A have a small contact angle on the surface with respect to adhered water droplets. Specifically, the rotor blade hydrophilic portions 3A are formed by performing surface treatment such as coating, etching, ultraviolet irradiation, blasting, or oxygen plasma with respect to the rotor blade surface 30. The rotor blade hydrophilic portions 3A extend toward the casing opening portion 17 in a linear shape inclined with respect to the axis Ar. The rotor blade hydrophilic portions 3A extend from a leading edge to a trailing edge of the rotor blade 32 with no clearance therebetween in the axial direction Da. The plurality of (five, in the present embodiment) rotor blade hydrophilic portions 3A are formed with a gap therebetween in the radial direction Dr with respect to the rotor blade surface 30 extending in the radial direction Dr. Namely, the plurality of rotor blade hydrophilic portions 3A are formed away from each other so as not to overlap each other in the radial direction Dr. Accordingly, when viewed in the circumferential direction Dc, the plurality of rotor blade hydrophilic portions 3A are formed in a strip shape arranged in the radial direction Dr. When viewed in the circumferential direction Dc, inclinations of the plurality of rotor blade hydrophilic portions 3A with respect to the axis Ar become larger as they become disposed at positions increasingly closer to the rotor shaft 21 in the radial direction Dr. Namely, the rotor blade hydrophilic portions 3A extending from near a root of the rotor blade 32 extend at an angle almost perpendicular to the axis Ar in a manner of extending in the radial direction Dr. On the other hand, the rotor blade hydrophilic portions 3A extending from near the tip of the rotor blade 32 extend at an angle almost parallel to the axis Ar in a manner of extending in the axial direction Da. The plurality of rotor blade hydrophilic portions 3A are formed throughout the entire area on the rotor blade surface 30 in the radial direction Dr.

In addition, the stator vane 42 disposed in at least one stage 50 of the present embodiment has a drain suction port 45, and a plurality of stator vane hydrophilic portions 4A on a stator vane surface 40 that is its own stator vane surface. In the present embodiment, the stator vanes 42 in the fifth stage 50E and the sixth stage 50F each have the drain suction port 45 and the stator vane hydrophilic portions 4A. Namely, the stator vane 42 forming a stage 50 together with the rotor blade 32 having the rotor blade hydrophilic portions 3A has the drain suction port 45 and the stator vane hydrophilic portions 4A.

The drain suction port 45 allows water droplets that have adhered to the stator vane surface 40 to flow in therethrough. The drain suction port 45 opens on the stator vane surface 40 extending in the radial direction Dr. The drain suction port 45 sends collected water droplets to a drain collection path (not shown) formed inside the stator vane 42 and discharges water droplets that have adhered to the stator vane surface 40 to the outside. The drain suction port 45 is formed throughout an end portion on the outward side Dro in the radial direction Dr from near the center of the stator vane 42 in the radial direction Dr. Namely, the drain suction port 45 is formed on the stator vane surface 40 as one long groove extending in the radial direction Dr. The drain suction port 45 is formed at a position closer to the trailing edge from the center of the stator vane 42 in the axial direction Da.

Each of the stator vane hydrophilic portions 4A guides water droplets that have adhered to the stator vane surface 40 toward the drain suction port 45. The stator vane hydrophilic portions 4A are formed to have higher hydrophilicity than the stator vane surface 40. Namely, water droplets are more likely to adhere to the stator vane hydrophilic portions 4A than to the stator vane surface 40. The stator vane hydrophilic portions 4A have approximately the same hydrophilicity as the rotor blade hydrophilic 5 portions 3A of the rotor blades 32 disposed on the downstream side. In order to enhance the hydrophilicity with respect to the stator vane surface 40, the stator vane hydrophilic portions 4A have a small contact angle on the surface with respect to adhered water droplets. Specifically, the stator vane hydrophilic portions 4A are formed by performing surface treatment such as coating, etching, ultraviolet irradiation, blasting, or oxygen plasma with respect to the stator vane surface 40. The stator vane hydrophilic portions 4A may be formed by the same method as the rotor blade hydrophilic portions 3A or may also be formed by a different method. The stator vane hydrophilic portions 4A extend toward the drain suction port 45 in a linear shape inclined with respect to the axis Ar. The stator vane hydrophilic portions 4A extend from a leading edge of the stator vane 42 to the drain suction port 45 with no clearance therebetween in the axial direction Da. The plurality of (five, in the present embodiment) stator vane hydrophilic portions 4A are formed with a gap therebetween in the radial direction Dr with respect to the stator vane surface 40 extending in the radial direction Dr. Namely, the plurality of stator vane hydrophilic portions 4A are formed away from each other so as not to overlap each other in the radial direction Dr. Accordingly, when viewed in the circumferential direction Dc, the plurality of stator vane hydrophilic portions 4A are formed in a strip shape arranged in the radial direction Dr. When viewed in the circumferential direction Dc, inclinations of the plurality of stator vane hydrophilic portions 4A with respect to the axis Ar become larger as they become disposed at positions increasingly closer to the rotor shaft 21 in the radial direction Dr. Namely, the stator vane hydrophilic portions 4A extending from near a root of the stator vane 42 extend at an angle almost perpendicular to the axis Ar in a manner of extending in the radial direction Dr. On the other hand, the stator vane hydrophilic portions 4A extending from near the tip of the stator vane 42 extend at an angle almost parallel to the axis Ar in a manner of extending in the axial direction Da. The plurality of stator vane hydrophilic portions 4A are formed throughout the entire area on the stator vane surface 40 in the radial direction Dr. In addition, when viewed in the circumferential direction Dc, the inclinations of the stator vane hydrophilic portions 4A are smaller than the inclinations of the rotor blade hydrophilic portions 3A which are formed in the rotor blade 32 disposed on the downstream side Dad and disposed at an overlapping position in the radial direction Dr. Namely, when viewed in the circumferential direction Dc, in the case of comparing the inclinations of the stator vane hydrophilic portions 4A and the rotor blade hydrophilic portions 3A positioned side by side in the axial direction Da, the inclinations of the rotor blade hydrophilic portions 3A are formed to be larger than the inclinations of the stator vane hydrophilic portions 4A.

### (Operational Effects)

In the steam turbine 1 having the foregoing constitution, the stator vanes 42 and the rotor blades 32 are disposed inside the main flow channel 15 through which the steam S circulates from the upstream side Dau toward the downstream side Dad in the axial direction Da. Inside the main flow channel 15, water droplets are generated in the steam S as the pressure of the steam S falls. For this reason, water droplets are more likely to be generated when being close to the last stage 50G on the downstream side Dad. As a result, the steam S circulates inside the main flow channel 15 in a state of containing water droplets. When the steam S flows near the stator vanes 42 and the rotor blades 32, water droplets in the steam S adhere to the stator vane surface 40 and the rotor blade surface 30 as fine water droplets due to inertia. As a result, water droplets (drain) adhere to the stator vane surface 40 and the rotor blade surface 30. Further, water droplets that have adhered to the stator vane surface 40 and the rotor blade surface 30 flow from the leading edge toward the trailing edge along the stator vane surface 40 and the rotor blade surface 30 such that liquid films are formed.

Specifically, water droplets that have adhered to the stator vane surface 40 come into contact with the stator vane hydrophilic portions 4A on the way toward the end portion of the trailing edge. Since the hydrophilicity of the stator vane hydrophilic portions 4A is higher than the hydrophilicity of the stator vane surface 40, water droplets that have come into contact with the stator vane hydrophilic portions 4A continue to flow on the stator vane hydrophilic portions 4A without returning to the stator vane surface 40 where the stator vane hydrophilic portions 4A are not formed. Here, the plurality of stator vane hydrophilic portions 4A are formed to guide water droplets toward the drain suction port 45. For this reason, water droplets that have flowed on the stator vane hydrophilic portions 4A flow into the drain suction port 45 formed in the stator vane 42 itself from above the stator vane hydrophilic portions 4A while flowing toward the end portion of the trailing edge. Water droplets that have flowed into the drain suction port 45 are discharged to the outside of the casing 10.

At this time, a plurality of stator vane hydrophilic portions 4A are formed with a gap therebetween in the radial direction Dr with respect to the stator vane surface 40. For this reason, no matter which position in the radial direction Dr a large amount of the steam S gathers and flows with respect to the stator vane surface 40, they can be brought into contact with any of the plurality of stator vane hydrophilic portions 4A. In addition, since the plurality of stator vane hydrophilic portions 4A extending in a linear shape are closely disposed with a gap therebetween in the radial direction Dr, compared to when one large hydrophilic portion is formed to cover a wide area on the stator vane surface 40, water droplets that have adhered to the stator vane hydrophilic portions 4A are likely to be induced in an intended direction. Namely, the flow of water droplets that have adhered to the stator vane hydrophilic portions 4A extending in a linear shape toward the drain suction port 45 can be stably induced toward the drain suction port 45. Therefore, they can be less likely to be affected by a flow field on the stator vane surface 40 which changes depending on driving conditions of the steam turbine 1, and liquid droplets and liquid films on the stator vane hydrophilic portions 4A can stably flow into the drain suction port 45.

In addition, water droplets that have adhered to the rotor blade surface 30 come into contact with the rotor blade hydrophilic portions 3A on the way toward the end portion of the trailing edge. Since the hydrophilicity of the rotor blade hydrophilic portions 3A is higher than the hydrophilicity of the rotor blade surface 30, water droplets that have come into contact with the rotor blade hydrophilic portions 3A continue to flow on the rotor blade hydrophilic portions 3A without returning to the rotor blade surface 30 where the rotor blade hydrophilic portions 3A are not formed. Here, the plurality of stator vane hydrophilic portions 4A are formed to guide water droplets toward the casing opening portion 17. For this reason, when water droplets that have flowed on the rotor blade hydrophilic portions 3A leave the end portion of the trailing edge, they gain momentum and are blown away toward the casing opening portion 17. Therefore, after leaving the end portion of the trailing edge, water droplets that have flowed on the rotor blade hydrophilic portions 3A flow into the casing opening portion 17 which is formed to be adjacent thereto in the axial direction Da. Water droplets that have flowed into the casing opening portion 17 are discharged to the outside of the casing 10.

At this time, a plurality of rotor blade hydrophilic portions 3A are formed with a gap therebetween in the radial direction Dr with respect to the rotor blade surface 30. For this reason, no matter which position in the radial direction Dr a large amount of the steam S gathers and flows with respect to the rotor blade surface 30, they can be brought into contact with any of the plurality of rotor blade hydrophilic portions 3A. In addition, since the plurality of rotor blade hydrophilic portions 3A extending in a linear shape are closely disposed with a gap therebetween in the radial direction Dr, compared to when one large hydrophilic portion is formed to cover a wide area on the rotor blade surface 30, water droplets that have adhered to the rotor blade hydrophilic portions 3A are likely to be induced in an intended direction. Namely, a flow of water droplets that have adhered to the rotor blade hydrophilic portions 3A extending in a linear shape toward the casing opening portion 17 can be stably induced toward the casing opening portion 17. Therefore, they can be less likely to be affected by a flow field on the rotor blade surface 30 which changes depending on driving conditions of the steam turbine 1, and liquid droplets and liquid films on the rotor blade hydrophilic portions 3A can stably flow into the casing opening portion 17.

By means of the plurality of stator vane hydrophilic portions 4A and the plurality of rotor blade hydrophilic portions 3A which are disposed away from each other in the radial direction Dr in this manner, it is possible to efficiently induce water droplets to the openings such as the drain suction port 45 and the casing opening portion 17 for discharging water droplets without depending on a flow of the steam S in the main flow channel 15.

In addition, in the plurality of rotor blade hydrophilic portions 3A, the inclinations of the rotor blade hydrophilic portions 3A with respect to the axis Ar become larger as they become disposed at positions increasingly closer to the rotor shaft 21 on the innermost side Dri in the radial direction Dr. For this reason, water droplets that have adhered near the root on the innermost side Dri in the radial direction Dr in the rotor blade 32 can also be sent to the casing opening portion 17 with high accuracy by the rotor blade hydrophilic portions 3A. Therefore, it is possible to improve the efficiency of collecting water droplets that have adhered to the rotor blade surface 30.

In addition, in the plurality of stator vane hydrophilic portions 4A, the inclinations of the stator vane hydrophilic portions 4A with respect to the axis Ar become larger as they become disposed at positions increasingly closer to the rotor shaft 21 on the innermost side Dri in the radial direction Dr. For this reason, liquid that has adhered near the root on the innermost side Dri in the radial direction Dr in the stator vane 42 can also be sent to the drain suction port 45 with high accuracy by the stator vane hydrophilic portions 4A. Therefore, it is possible to improve the efficiency of collecting water droplets that have adhered to the stator vane surface 40.

In addition, the stator vane hydrophilic portions 4A extend from the leading edge of the stator vane 42 to the drain suction port 45. Therefore, water droplets that have adhered near the leading edge of the stator vane 42 can also be stably sent to the drain suction port 45. Therefore, it is possible to improve the efficiency of collecting water droplets that have adhered to the stator vane surface 40.

In addition, when viewed in the circumferential direction Dc, the inclinations of the plurality of rotor blade hydrophilic portions 3A with respect to the axis Ar are larger than the inclinations of the plurality of stator vane hydrophilic portions 4A with respect to the axis Ar disposed at the same position in the radial direction Dr. For this reason, water droplets flowing on the rotor blade hydrophilic portions 3A can be sent with high accuracy to the casing opening portion 17 which opens on the inner circumferential surface of the casing 10 facing the tips of the rotor blades 32 and is positioned on the outward side Dro in the radial direction Dr with respect to the rotor blades 32. Therefore, it is possible to improve the efficiency of collecting water droplets that have adhered to the rotor blade surface 30.

In addition, the rotor blade hydrophilic portions 3A extend from the leading edge to the trailing edge of the rotor blade 32. Therefore, water droplets that have adhered near the leading edge of the rotor blade 32 can also be stably sent to the trailing edge and can be blown away to the casing opening portion 17. Therefore, it is possible to improve the efficiency of collecting water droplets that have adhered to the rotor blade surface 30.

### OTHER EMBODIMENTS

Hereinabove, an embodiment of the present disclosure has been described in detail with reference to the drawings. However, a specific constitution is not limited to this embodiment, and design change and the like within a range not departing from the gist of the present disclosure are also included.

For example, including the number of stages having the rotor blade row 31 and the stator vane row 41, and the like, the constitution of each portion of the steam turbine 1 can be suitably changed. Namely, the steam turbine 1 is not limited to a structure having seven stages (seven rotor blade rows 31 and seven stator vane rows 41) as in the present embodiment. Therefore, the steam turbine 1 may have six or fewer stages or may have eight or more stages.

In addition, the stator vane 42 having the stator vane hydrophilic portions 4A formed therein and the rotor blade 32 having the rotor blade hydrophilic portions 3A formed therein are not limited to only some of a plurality of stages 50 as in the fifth stage 50E and the sixth stage 50F of the present embodiment. The stator vane 42 having the stator vane hydrophilic portions 4A formed therein and the rotor blade 32 having the rotor blade hydrophilic portions 3A formed therein may be formed in all the stages 50.

In addition, the stator vane 42 having the stator vane hydrophilic portions 4A formed therein and the rotor blade 32 having the rotor blade hydrophilic portions 3A formed therein may be formed in some stages 50 or may be formed in an area including the last stage 50G.

In addition, the number and shapes of stator vane hydrophilic portions 4A and rotor blade hydrophilic portions 3A to be formed are not limited to the shapes as in the present embodiment. For example, the stator vane hydrophilic portions 4A and the rotor blade hydrophilic portions 3A are not limited to having a linear shape and may also be formed to have a curve shape.

### APPENDIX

The steam turbine 1 according to the embodiment is ascertained as follows, for example.

(1) A steam turbine 1 according to a first aspect includes a rotor shaft 21 which is capable of rotating about an axis Ar, a plurality of rotor blades 32 which are fixed to an outward side of the rotor shaft 21 in a radial direction Dr with respect to the axis Ar, a casing 10 which covers the rotor shaft 21 and the plurality of rotor blades 32 from the outward side Dro in the radial direction Dr and in which a main flow channel 15 allowing steam S to circulate therethrough is formed, and a plurality of stator vanes 42 which are fixed to an inward side Dri of the casing 10 in the radial direction Dr and disposed on a first side in an axial direction Da with respect to the plurality of rotor blades 32. The steam turbine 1 includes a plurality of stages 50 which constituted of pairs of the rotor blade 32 and the stator vane 42 arranged in the axial direction Da are provided. The casing 10 has a casing opening portion 17 which opens on an inner circumferential surface facing tip of each of the rotor blades 32 and allows water droplets circulating in the main flow channel 15 to flow in therethrough on a second side in the axial direction Da with respect to the rotor blades 32 in at least one of the stages 50. The rotor blade 32, which disposed in at least one of the stages, has a plurality of rotor blade hydrophilic portions 3A which are formed with a gap therebetween in the radial direction Dr with respect to a rotor blade surface 30 extending in the radial direction Dr and guide the water droplets that have adhered to the rotor blade surface 30 toward the casing opening portion 17. The stator vane 42, which disposed in at least one of the stages 50, has a drain suction port 45 which opens on a stator vane surface 40 extending in the radial direction Dr and allows the water droplets that have adhered to the stator vane surface 40 to flow in therethrough, and a plurality of stator vane hydrophilic portions 4A which are formed with a gap therebetween in the radial direction Dr with respect to the stator vane surface 40 and guide the water droplets that have adhered to the stator vane surface 40 toward the drain suction port 45.

In such a steam turbine 1, water droplets that have adhered to the stator vane surface 40 come into contact with the stator vane hydrophilic portions 4A. Water droplets that have flowed on the stator vane hydrophilic portions 4A flow into the drain suction port 45. At this time, a plurality of stator vane hydrophilic portions 4A are formed with a gap therebetween in the radial direction Dr with respect to the stator vane surface 40. For this reason, no matter which position in the radial direction Dr a large amount of the steam S gathers and flows with respect to the stator vane surface 40, they can be brought into contact with any of the plurality of stator vane hydrophilic portions 4A. In addition, since the plurality of stator vane hydrophilic portions 4A are disposed with a gap therebetween in the radial direction Dr, compared to when a hydrophilic portion is formed to cover a wide area on the stator vane surface 40, water droplets that have adhered to the stator vane hydrophilic portions 4A can be induced in an intended direction. Namely, a flow of water droplets that have adhered to the stator vane hydrophilic portions 4A can be stably induced toward the drain suction port 45.

Therefore, they can be less likely to be affected by a flow field on the stator vane surface 40 which changes depending on driving conditions of the steam turbine 1, and liquid droplets and liquid films on the stator vane hydrophilic portions 4A can stably flow into the drain suction port 45.

In addition, water droplets that have adhered to the rotor blade surface 30 come into contact with the rotor blade hydrophilic portions 3A. Water droplets that have flowed on the rotor blade hydrophilic portions 3A gain momentum and are blown away toward the casing opening portion 17. Therefore, water droplets that have flowed on the rotor blade hydrophilic portions 3A flow into the casing opening portion 17. At this time, a plurality of rotor blade hydrophilic portions 3A are formed with a gap therebetween in the radial direction Dr with respect to the rotor blade surface 30. For this reason, no matter which position in the radial direction Dr a large amount of the steam S gathers and flows with respect to the rotor blade surface 30, they can be brought into contact with any of the plurality of rotor blade hydrophilic portions 3A. In addition, since the plurality of rotor blade hydrophilic portions 3A are disposed with a gap therebetween in the radial direction Dr, compared to when a hydrophilic portion is formed cover a wide area on the rotor blade surface 30, water droplets that have adhered to the rotor blade hydrophilic portions 3A can be induced in an intended direction. Namely, a flow of water droplets that have adhered to the rotor blade hydrophilic portions 3A can be stably induced toward the casing opening portion 17. Therefore, they can be less likely to be affected by a flow field on the rotor blade surface 30 which changes depending on driving conditions of the steam turbine 1, and liquid droplets and liquid films on the rotor blade hydrophilic portions 3A can stably flow into the casing opening portion 17.

By means of the plurality of stator vane hydrophilic portions 4A and the plurality of rotor blade hydrophilic portions 3A which are disposed away from each other in the radial direction Dr in this manner, it is possible to efficiently induce water droplets to the openings such as the drain suction port 45 and the casing opening portion 17 without depending on a flow of the steam S in the main flow channel 15.

(2) The steam turbine 1 according to a second aspect is the steam turbine 1 according to (1) in which inclinations of the plurality of rotor blade hydrophilic portions 3A with respect to the axis Ar become larger in the plurality of rotor blade hydrophilic portions 3A become disposed at positions increasingly closer to the rotor shaft 21 in the radial direction Dr among the plurality of rotor blade hydrophilic portions 3A.

Accordingly, water droplets that have adhered near the root on the innermost side Dri in the radial direction Dr in the rotor blade 32 can also be sent to the casing opening portion 17 with high accuracy by the rotor blade hydrophilic portions 3A. Therefore, it is possible to improve the efficiency of collecting water droplets that have adhered to the rotor blade surface 30.

(3) The steam turbine 1 according to a third aspect is the steam turbine 1 according to (1) or (2) in which inclinations of the plurality of stator vane hydrophilic portions 4A with respect to the axis Ar are formed to be larger in the plurality of stator vane hydrophilic portions 4A become disposed at positions increasingly closer to the rotor shaft 21 in the radial direction Dr among the plurality of stator vane hydrophilic portions 4A.

Accordingly, water droplets that have adhered near the root on the innermost side Dri in the radial direction Dr in the stator vane 42 can also be sent to the drain suction port 45 with high accuracy by the stator vane hydrophilic portions 4A. Therefore, it is possible to improve the efficiency of collecting water droplets that have adhered to the stator vane surface 40.

(4) The steam turbine 1 according to a fourth aspect is any one of the steam turbines 1 according to (1) to (3) in which inclinations of the plurality of rotor blade hydrophilic portions 3A with respect to the axis Ar are larger than inclinations of the plurality of stator vane hydrophilic portions 4A with respect to the axis Ar.

Accordingly, water droplets flowing on the rotor blade hydrophilic portions 3A can be sent with high accuracy to the casing opening portion 17 which is positioned on the outward side Dro in the radial direction Dr with respect to the rotor blades 32. Therefore, it is possible to improve the efficiency of collecting water droplets that have adhered to the rotor blade surface 30.

(5) The steam turbine 1 according to a fifth aspect is any one of the steam turbines 1 according to (1) to (4) in which the stator vane hydrophilic portions 4A extend from a leading edge of the stator vane 42 to the drain suction port 45.

Accordingly, water droplets that have adhered near the leading edge of the stator vane 42 can also be stably sent to the drain suction port 45. Therefore, it is possible to improve the efficiency of collecting water droplets that have adhered to the stator vane surface 40.

(6) The steam turbine 1 according to a sixth aspect is any one of the steam turbines 1 according to (1) to (5) in which the rotor blade hydrophilic portions 3A extend from a leading edge to a trailing edge of the rotor blade 32.

Accordingly, water droplets that have adhered near the leading edge of the rotor blade 32 can also be stably sent to the trailing edge and can be blown away to the casing opening portion 17. Therefore, it is possible to improve the efficiency of collecting water droplets that have adhered to the rotor blade surface 30.

### EXPLANATION OF REFERENCES

1 Steam turbine
S Steam
Ar Axis
20 Rotor
21 Rotor shaft
22 Shaft core portion
23 Disk portion
31 Rotor blade row
32 Rotor blade
30 Rotor blade surface
3A Rotor blade hydrophilic portion
10 Casing
11 Nozzle chamber
12 Flow channel chamber
13 Exhaust chamber
15 Main flow channel
50 Stage
51 Exhaust casing
70 Diffuser
17 Casing opening portion
41 Stator vane row
42 Stator vane
40 Stator vane surface
45 Drain suction port
4A Stator vane hydrophilic portion
Da Axial direction
Dau Upstream side
Dad Downstream side
Dr Radial direction
Dri Inward side
Dro Outward side
Dc Circumferential direction

What is claimed is:

1. A steam turbine comprising:
a rotor shaft which is capable of rotating about an axis;
a plurality of rotor blades which are fixed to an outward side of the rotor shaft in a radial direction with respect to the axis;
a casing which covers the rotor shaft and the plurality of rotor blades from the outward side in the radial direction and in which a main flow channel allowing steam to circulate therethrough is formed; and
a plurality of stator vanes which are fixed to an inward side of the casing in the radial direction and disposed on a first side in an axial direction with respect to the plurality of rotor blades,
wherein the steam turbine comprises a plurality of stages which constituted of pairs of each of the plurality of rotor blades and each of the plurality of stator vanes arranged in the axial direction,
the casing has a casing opening portion which opens on an inner circumferential surface facing tip of each of the plurality of rotor blades and allows water droplets circulating in the main flow channel to flow in therethrough on a second side in the axial direction with respect to each of the plurality of rotor blades in at least one of the plurality of stages,
each of the plurality of rotor blades, which disposed in at least one of the plurality of stages, has a plurality of rotor blade hydrophilic portions which are formed with a gap therebetween in the radial direction with respect to a rotor blade surface extending in the radial direction and guide the water droplets that have adhered to the rotor blade surface toward the casing opening portion, and
each of the plurality of stator vanes, which disposed in at least one of the plurality of stages, has
a drain suction port which opens on a stator vane surface extending in the radial direction and allows the water droplets that have adhered to the stator vane surface to flow in therethrough, and
a plurality of stator vane hydrophilic portions which are formed with a gap therebetween in the radial direction with respect to the stator vane surface and guide the water droplets that have adhered to the stator vane surface toward the drain suction port.

2. The steam turbine according to claim 1,
wherein inclinations of the plurality of rotor blade hydrophilic portions with respect to the axis become larger in the plurality of rotor blade hydrophilic portions become disposed at positions increasingly closer to the rotor shaft in the radial direction among the plurality of rotor blade hydrophilic portions.

3. The steam turbine according to claim 1,
wherein inclinations of the plurality of stator vane hydrophilic portions with respect to the axis are formed to be larger in the plurality of stator vane hydrophilic portions become disposed at positions increasingly closer to the rotor shaft in the radial direction among the plurality of stator vane hydrophilic portions.

4. The steam turbine according to claim 1,
wherein inclinations of the plurality of rotor blade hydrophilic portions with respect to the axis are larger than inclinations of the plurality of stator vane hydrophilic portions with respect to the axis.

5. The steam turbine according to claim 1,
wherein each of the plurality of stator vane hydrophilic portions extends from a leading edge of each of the plurality of stator vanes to the drain suction port.

6. The steam turbine according to claim 1,
wherein each of the plurality of rotor blade hydrophilic portions extends from a leading edge to a trailing edge of each of the plurality of rotor blades.
